(19) United States
(12) Patent Application Publication
(10) Pub. No.: US 2018/0338476 A1
(43) Pub. Date: Nov. 29, 2018

(54) Beehive Pest Control Assembly

(71) Applicant: Michael S. Richardson, Springfield, MO (US)

(72) Inventor: Michael S. Richardson, Springfield, MO (US)

(21) Appl. No.: 15/982,763

(22) Filed: May 17, 2018

Related U.S. Application Data
(60) Provisional application No. 62/510,635, filed on May 24, 2017.

(51) Int. Cl. A01K 47/06

(52) U.S. Cl. CPC A01K 47/06

(57) ABSTRACT

A beehive pest control assembly includes a hive box that has a perimeter wall with an upper edge defining an opening extending into the hive box. A cover has a size to be positioned on the upper edge and cover the opening such that the opening is closed. The cover has a top wall and a perimeter edge. The cover is translucent and is colored red such that only red light is transmitted into the hive box when light is transmitted through the top wall and into the hive box. The red light disturbs unwanted insects and causes these insects to leave the hive box.

### CROSS-REFERENCE TO RELATED APPLICATIONS

I hereby claim the benefit under 35 U.S.C. Section 119(e) of U.S. Provisional application 62/510,635 filed May 24, 2017.

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM.

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

### (2) Description of Related Art Including Information Disclosed under 37 CFR 1.97 and 1.98.

The disclosure and prior art relates to beehive pest control devices and more particularly pertains to a new beehive pest control device for driving insects out of a honey bee colony hive box.

### BRIEF SUMMARY OF THE INVENTION

An embodiment of the disclosure meets the needs presented above by generally comprising a hive box that has a perimeter wall with an upper edge defining an opening extending into the hive box. A cover has a size to be positioned on the upper edge and cover the opening such that the opening is closed. The cover has a top wall and a perimeter edge. The cover is translucent and is colored red such that only red light is transmitted into the hive box when light is transmitted through the top wall and into the hive box. The red light disturbs unwanted insects and causes these insects to leave the hive box.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a top isometric view of a cover of a beehive pest control assembly according to an embodiment of the disclosure.

FIG. 2 is a bottom isometric view of an embodiment of the disclosure.

FIG. 3 is an exploded, side isometric in-use view of an embodiment of the disclosure.

FIG. 4 is a cross-sectional view of an embodiment of the disclosure taken along line 4-4 of FIG. 3.

### DETAILED DESCRIPTION OF THE INVENTION

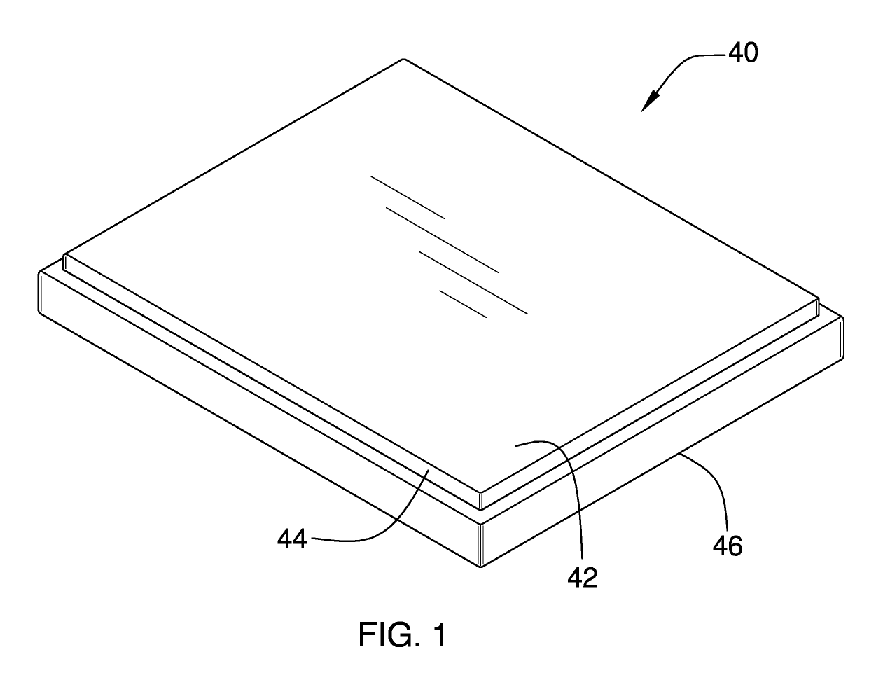

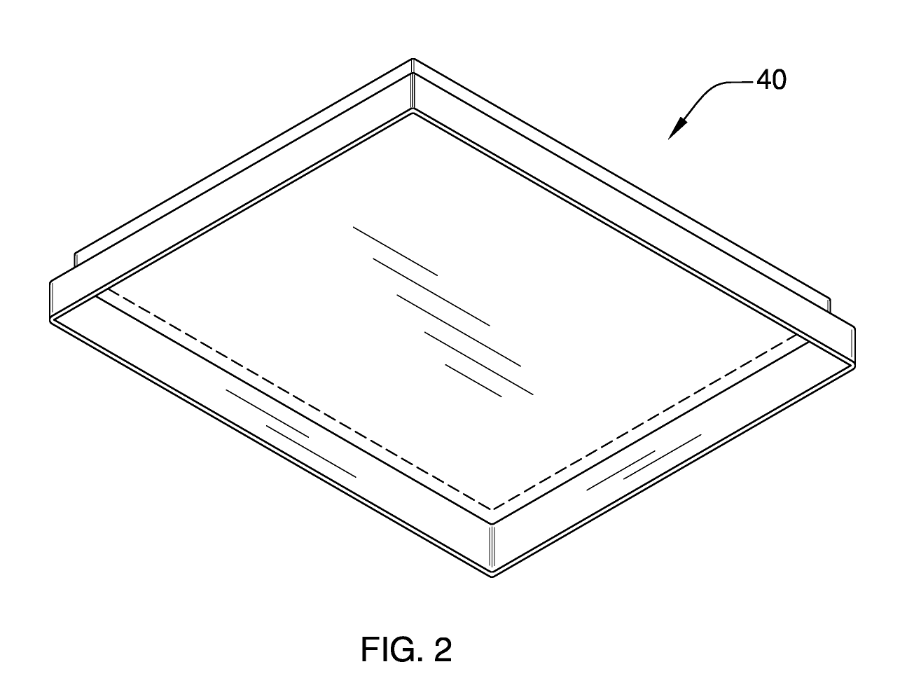

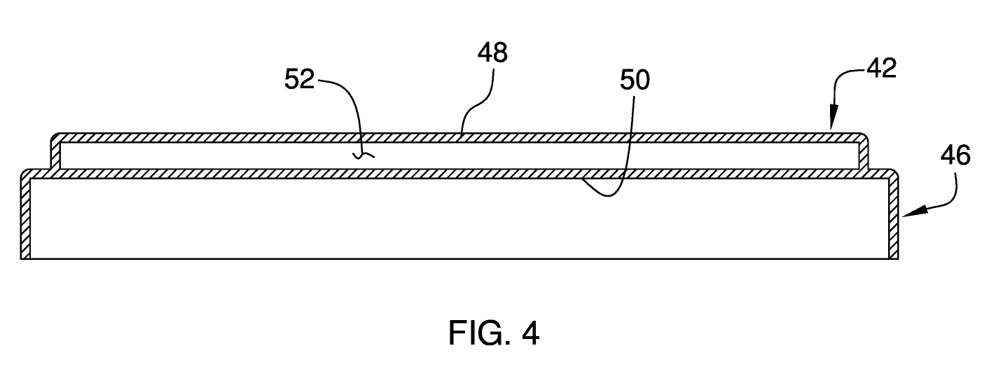

With reference now to the drawings, and in particular to FIGS. 1 through 4 thereof, a new beehive pest control device embodying the principles and concepts of an embodiment of the disclosure and generally designated by the reference numeral 10 will be described.

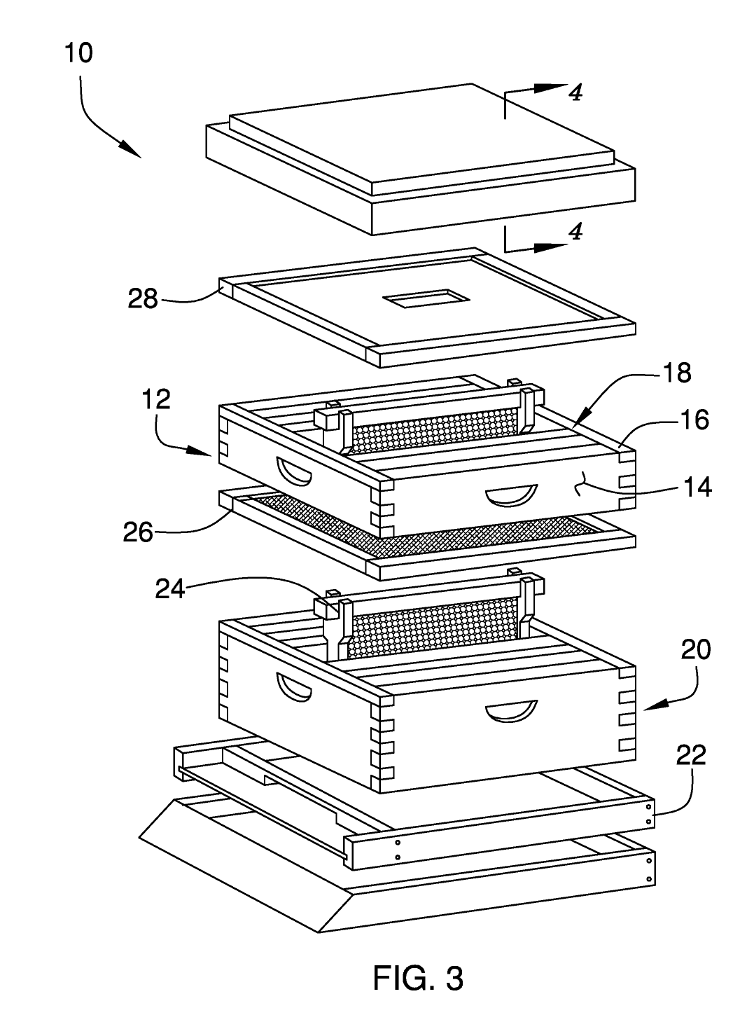

As best illustrated in FIGS. 1 through 4, the beehive pest control assembly 10 generally comprises a conventional hive box 12 that has a perimeter wall 14 with an upper edge 16 defining an opening 18 extending into the hive box 12. As can be seen in FIG. 3, the hive box 12 includes conventional components which may comprise one or more brood boxes 20, a floor 22, frames 24, a queen excluder 26 and a crown board 28. For reasons which will become apparent below, the crown board 28 may comprise a translucent or transparent material allowing light to pass therethrough.

A cover 40 is provided that has a size configured to be positioned on the upper edge 16 and cover the opening 18 such that the opening 18 is closed. The cover 40 takes the place of what would typically be a roof of a hive box 12. The cover 40 has a top wall 42 and a perimeter edge 44. The cover 40 is translucent but is colored red such that only red light is transmitted into the hive box 12 when light is transmitted through the top wall 42 and into the hive box 12. More specifically, the red light will typically have a wavelength of 620 nm to 700 nm. A perimeter flange 46 is attached to and extends downwardly from the perimeter edge 44. The perimeter flange 46 extends around the perimeter wall 14 and releasably retains the cover 40 on the hive box 12. The top wall 42 and perimeter flange 46 may be comprised of a unitary structure and may more particularly be comprised of a plastic material.

The top wall 42 includes an upper panel 48 and lower panel 50. The upper 48 and lower 50 panels are spaced from each other to define an air space 52 between the upper 48 and lower 50 panels. This structure forms a thermal barrier between an upper surface of the upper panel 48 and a lower surface of the lower panel 50 while allowing light to still pass therethrough. The upper 48 and lower 50 panels may therefore be defined as lenses allowing red light to enter the hive box 12 through the cover 40.

In additional embodiments, not found in the Figures, the hive box 12 may be equipped with light emitters, such as light emitting diodes, which emit red light at a desired frequency. That desired frequency is most preferably red light having wavelengths from 620 nm to 700 nm. Varying power supplies may be used which are electrically coupled to the light emitters such a power cord directly coupled to the light emitters, batteries, rechargeable batteries, solar panels, and the like. Moreover, an ambient light detector may be electrically coupled to the light emitters to only turn on the light emitters at preselected times.

In use, the hive box 12 is used in a conventional manner, however, its standard roof is removed and replaced with the cover 40. During periods of sunlight, the red light within the hive box 12 discourages insects, such as small hive beetles and wax moths, from entering into and living within the hive box. These insects stress the hive and will lower honey production and may ultimately disrupt a colony of bees. While honey bees do not like light, they do not see red light. However, while insects such as the small hive beetles do not like light either, they can detect the red light which ultimately drives the small hive beetles from the hive box 12.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A beehive pest control assembly configured to deter unwanted insects from infiltrating a beehive, the assembly comprising:
a hive box having a perimeter wall having an upper edge defining an opening extending into the hive box;
a cover having a size configured to be positioned on the upper edge and cover the opening such that the opening is closed, the cover having a top wall and a perimeter edge, the cover being translucent, the cover being colored red such that only red light is transmitted into the hive box when light is transmitted through the top wall and into the hive box.

2. The beehive pest control assembly according to claim 1, wherein the red light has a wavelength of 620 nm to 700 nm.

3. The beehive pest control assembly according to claim 1, wherein a perimeter flange is attached to and extends downwardly from the perimeter edge, the perimeter flange extending around the perimeter wall and releasably retaining the cover on the hive box.

4. The beehive pest control assembly according to claim 1, wherein the top wall includes an upper panel and lower panel, the upper and lower panels being spaced from each other to define an air space between the upper and lower panels and forming a thermal barrier between an upper surface of the upper panel and a lower surface of the lower panel.

5. The beehive pest control assembly according to claim 2, wherein the top wall includes an upper panel and lower panel, the upper and lower panels being spaced from each other to define an air space between the upper and lower panels and forming a thermal barrier between an upper surface of the upper panel and a lower surface of the lower panel.

6. A beehive pest control assembly configured to be positioned over an opening of a hive box to deter unwanted insects from infiltrating a beehive, the assembly comprising:
a cover having a size configured to be positioned on an upper edge of a perimeter wall of a hive box to cover an opening of the hive box such that the opening is closed, the cover having a top wall and a perimeter edge, the cover being translucent, the cover being colored red such that only red light is transmitted into the hive box when light is transmitted through the top wall and into the hive box.

7. The beehive pest control assembly according to claim 6, wherein the red light has a wavelength of 620 nm to 700 nm.

8. The beehive pest control assembly according to claim 7, wherein a perimeter flange is attached to and extends downwardly from the perimeter edge, the perimeter flange being configured to be extended around the perimeter wall and releasably retain the cover on the hive box.

9. The beehive pest control assembly according to claim 8, wherein the top wall includes an upper panel and lower panel, the upper and lower panels being spaced from each other to define an air space between the upper and lower panels and forming a thermal barrier between an upper surface of the upper panel and a lower surface of the lower panel.

10. The beehive pest control assembly according to claim 6, wherein the top wall includes an upper panel and lower panel, the upper and lower panels being spaced from each other to define an air space between the upper and lower panels and forming a thermal barrier between an upper surface of the upper panel and a lower surface of the lower panel.

11. A beehive pest control assembly configured to deter unwanted insects from infiltrating a beehive, the assembly comprising:
a hive box having a perimeter wall having an upper edge defining an opening extending into the hive box;
a cover having a size configured to be positioned on the upper edge and cover the opening such that the opening is closed, the cover having a top wall and a perimeter edge, the cover being translucent, the cover being colored red such that only red light is transmitted into the hive box when light is transmitted through the top wall and into the hive box, the red light having a wavelength of 620 nm to 700 nm, a perimeter flange being attached to and extending downwardly from the perimeter edge, the perimeter flange extending around the perimeter wall and releasably retaining the cover on the hive box; and
the top wall including an upper panel and lower panel, the upper and lower panels being spaced from each other to define an air space between the upper and lower panels and forming a thermal barrier between an upper surface of the upper panel and a lower surface of the lower panel.
